(19) United States
(12) Patent Application Publication
(10) Pub. No.: US 2025/0148830 A1
(43) Pub. Date: May 8, 2025

(54) ACTION EVALUATION SYSTEM, ACTION EVALUATION METHOD, AND NON-TRANSITORY COMPUTER-READABLE MEDIUM

(71) Applicant: NEC Corporation, Minato-ku, Tokyo (JP)

(72) Inventors: Noboru YOSHIDA, Tokyo (JP); Ryo KAWAI, Tokyo (JP); Jianquan LIU, Tokyo (JP)

(73) Assignee: NEC Corporation, Minato-ku, Tokyo (JP)

(21) Appl. No.: 18/835,088

(22) PCT Filed: Feb. 9, 2022
(86) PCT No.: PCT/JP2022/005114

§ 371 Date: Aug. 1, 2024

(51) Int. Cl. G06V 40/20; G06Q 10/0639

(52) U.S. Cl. CPC G06V 40/23; G06Q 10/06398

(57) ABSTRACT

According to the present disclosure, it is possible to provide an action evaluation system, an action evaluation method, and the like for appropriately evaluating efficiency of a series of operations performed by a worker. An action evaluation system according to an example embodiment can include an action detection unit that detects a plurality of unit actions included in a series of operations performed by a worker from image data, according to a stored unit action pattern, and a time measurement unit that measures a time taken for the series of operations. The time measurement unit can also measure a time of each detected unit action and a time between the unit actions.

### TECHNICAL FIELD

The present disclosure relates to an action evaluation system, an action evaluation method, and a non-transitory computer-readable medium.

### BACKGROUND ART

In a distribution warehouse, an automobile manufacturing site, or the like, one worker performs a series of operations including a plurality of unit operations. Technology for evaluating a series of operations performed by such a worker has been developed.

For example, a distribution operation analysis system described in Patent Literature 1 automatically specifies operation contents of a distribution worker.

In addition, an operation analysis apparatus described in Patent Literature 2 analyzes what kind of operation is performed by a worker who performs an operation such as construction.

In addition, an operation analysis apparatus described in Patent Literature 3 estimates a joint position from video of a worker, acquires time-series data of the joint position from an estimation result, and determines efficiency of an operation based on the time-series data.

### CITATION LIST

### Patent Literature

Patent Literature 1: Japanese Unexamined Patent Application Publication No. 2017-010186

Patent Literature 2: Japanese Unexamined Patent Application Publication No. 2021-067981

Patent Literature 3: International Patent Publication No. WO2021/131552

### SUMMARY OF INVENTION

### Technical Problem

It may be difficult to appropriately evaluate operation efficiency. For example, a part of an operation may include a process performed by a worker in any order. In particular, it is desired to appropriately evaluate operation efficiency even in such an operation.

In view of the above-described problems, an object of the present disclosure is to provide an action evaluation system and the like for appropriately evaluating efficiency of an operation performed by a worker.

### Solution to Problem

An action evaluation system according to an aspect of the present disclosure includes
an action detection means for detecting a plurality of unit actions included in a series of operations performed by a worker from image data according to a stored unit action pattern, and
a time measurement means for measuring a time taken for the series of operations.

An action evaluation method according to an aspect of the present disclosure includes
detecting a plurality of unit actions included in a series of operations performed by a worker from image data according to a stored unit action pattern, and
measuring a time taken for the series of operations.

A non-transitory computer-readable medium according to an aspect of the present disclosure stores a program causing a computer to execute
detecting a plurality of unit actions included in a series of operations performed by a worker from image data according to a stored unit action pattern, and
measuring a time taken for the series of operations.

### Advantageous Effects of Invention

According to the present disclosure, it is possible to provide an action evaluation system and the like for appropriately evaluating efficiency of a series of operations performed by the worker.

### BRIEF DESCRIPTION OF DRAWINGS

FIG. 1 is a block diagram illustrating a configuration of an action evaluation system according to a first example embodiment.

FIG. 2 is a flowchart illustrating an action evaluation method according to the first example embodiment.

FIG. 3 is a diagram illustrating an overall configuration of an action evaluation system according to a second example embodiment.

FIG. 4 is a flowchart illustrating an action evaluation method according to the second example embodiment.

FIG. 5 is a diagram illustrating an example of image data acquired by the action evaluation system.

FIG. 6 is a diagram illustrating skeleton data extracted from image data.

FIG. 7 is a table illustrating an example of a registration action stored in a storage unit according to the second example embodiment.

FIG. 8 is a diagram illustrating a first example of skeleton data in the registration action.

FIG. 9 is a diagram illustrating a second example of skeleton data in the registration action.

FIG. 10 is a diagram illustrating an example of a determination result and a measurement result output by the action evaluation system according to the second example embodiment.

FIG. 11 is a diagram for comparing a detected operation time with a reference operation time.

FIG. 12 is a diagram illustrating another example of a determination result and a measurement result output by the action evaluation system according to the second example embodiment.

FIG. 13 is a diagram for comparing a detected operation time with a reference operation time.

FIG. 14 is a diagram illustrating an overall configuration of an action evaluation system according to a third example embodiment.

FIG. 15 is a block diagram illustrating a configuration of an action evaluation apparatus according to the third example embodiment. FIG. 16 is a block diagram illustrating a configuration of a process management apparatus according to the third example embodiment.

FIG. 17 is a flowchart illustrating an action evaluation method according to the third example embodiment.

FIG. 18 is a table illustrating an example of an operation action stored in the action evaluation system according to the third example embodiment.

FIG. 19 is a flowchart illustrating processing of registering a registration action according to the third example embodiment.

FIG. 20 is a block diagram illustrating a hardware configuration example of the action evaluation system or the like.

### EXAMPLE EMBODIMENT

Hereinafter, the present disclosure will be described through example embodiments, but the disclosure according to the claims is not limited to the following example embodiments. In addition, not all the configurations described in the example embodiment are essential as means for solving the problem. In the drawings, the same elements are denoted by the same reference numerals, and repeated description is omitted as necessary.

### First Example Embodiment

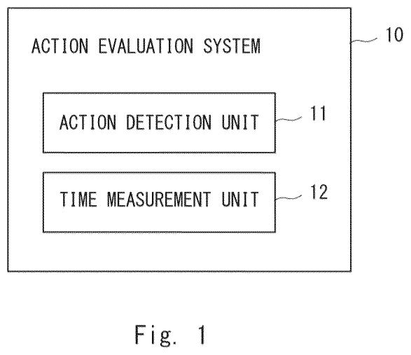

FIG. 1 is a block diagram illustrating a configuration of an action evaluation system according to a first example embodiment.

The action evaluation system 10 includes an action detection unit 11 that detects a plurality of unit actions included in a series of operations performed by a worker from image data according to a stored unit action pattern, and a time measurement unit 12 that measures a time taken for the series of operations.

The action detection unit 11 is also referred to as an action detection means, and in some example embodiments, sets a feature point and a pseudo skeleton of a body of a person based on image data and detects a plurality of unit actions included in a series of operations from the image data according to a stored unit action pattern. Furthermore, in another example embodiment, the action detection unit 11 recognizes an action of the body of the person in time series based on the image data in a plurality of consecutive frames.

The time measurement unit 12 is also referred to as a time measurement means, and in some example embodiments, can also measure a time of each detected unit action and a time between the unit actions. In another example embodiment, the time measurement unit 12 further includes a comparison and evaluation means for performing comparison and evaluation between a time of the series of operations performed by the worker and a time of a reference operation stored in advance.

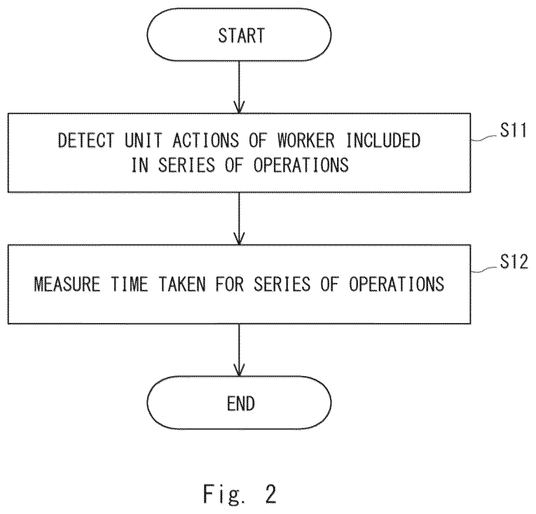

FIG. 2 is a flowchart illustrating an action evaluation method according to the first example embodiment.

The action detection unit 11 detects a plurality of unit actions included in the series of operations performed by the worker according to the stored unit action pattern (step S11). The time measurement unit 12 measures a time taken for the series of operations (step S12).

The action evaluation system according to the first example embodiment has been described above. The action evaluation system 10 includes a processor and a storage apparatus as components (not illustrated). The storage apparatus included in the action evaluation system 10 includes, for example, a storage apparatus including a non-volatile memory such as a flash memory or a solid state drive (SSD). In this case, the storage apparatus included in the action evaluation system 10 stores a computer program (hereinafter, also simply referred to as a program) for executing the above-described image processing method. In addition, the processor reads a computer program from the storage apparatus into a buffer memory such as a dynamic random access memory (DRAM), and executes the program.

Each component included in the action evaluation system 10 may be realized by dedicated hardware. Some or all of the elements may be implemented by general-purpose or dedicated circuitry, a processor, or the like, or a combination thereof. These units may be configured with a single chip or may be configured with a plurality of chips connected via a bus. Some or all of elements of each apparatus may be implemented by a combination of the above-described circuit or the like and a program. Furthermore, as the processor, a central processing unit (CPU), a graphics processing unit (GPU), a field-programmable gate array (FPGA), or the like can be used. Note that the description regarding the configuration described here can also be applied to other apparatuses or systems described below in the present disclosure.

Furthermore, when some or all of the elements of the action evaluation system 10 are implemented by a plurality of information processing apparatuses, circuits, and the like, the plurality of information processing apparatuses, circuits, and the like may be arranged in a centralized manner or in a distributed manner. For example, the information processing apparatuses, the circuits, and the like may be implemented in the form of a client server system, a cloud computing system, or the like in which they are connected to each other via a communication network. Furthermore, the function of the action evaluation system 10 may be provided in a software as a service (SaaS) format.

According to the present example embodiment, it is possible to provide an action evaluation system and the like for appropriately evaluating efficiency of an operation performed by the worker.

### Second Example Embodiment

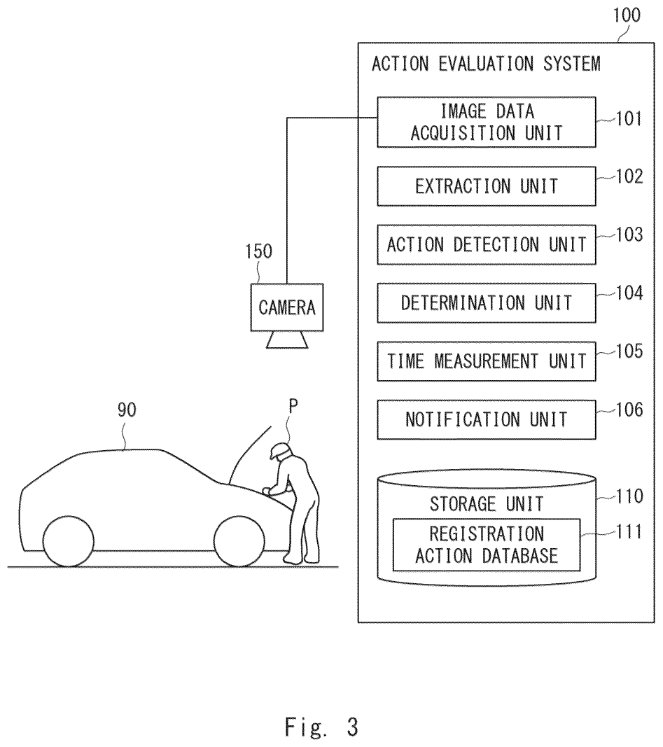

FIG. 3 is a diagram illustrating an overall configuration of an action evaluation system according to a second example embodiment. FIG. 3 includes an automobile 90, a worker P, an action evaluation system 100, and a camera 150. The action evaluation system 100 detects an action of the worker similar to one or more unit action patterns stored in advance from captured data obtained by capturing a series of operations performed by the worker, and evaluates efficiency of the operations. As used herein, the series of operations performed by the worker refers to operations including a plurality of unit operations and including operations that can be determined in execution order at the discretion of the worker. In some example embodiments, in the series of operations, one or more first and last unit actions are determined in advance, and an order of a series of operations therebetween can be determined at the discretion of the worker. Such a series of operations can vary in operation efficiency for each worker, but it is difficult to appropriately evaluate the operation efficiency. Therefore, the present example embodiment proposes an action evaluation system that appropriately evaluates efficiency of such an operation.

Hereinafter, an example applied to an automobile inspection process will be described, but the present invention is not limited thereto. For example, the present invention can be applied to operations in various fields such as an operation of moving a large number of products in a cardboard box from the cardboard box to another container in a distribution base and packing in a moving operation.

The automobile 90 is one aspect of an operation object. In the present example embodiment, the automobile 90 is in a state in which an assembly process is completed and the automobile is put in an inspection process in an automobile manufacturing factory. In the inspection process, the automobile 90 receives an inspection executed by a worker P. In the inspection process, the worker P inspects whether the automobile 90 has a function or performance as specified.

The camera 150 captures an image or video including an operation action performed by the worker P in the inspection process of the automobile 90. The camera 150 captures this image every predetermined period, generates image data for each of the captured images, and sequentially supplies the image data to the action evaluation system 100. The predetermined period is, for example, 1/15 second, 1/30 second, 1/60 second, or the like. Even though the number of the cameras 150 illustrated in FIG. 3 is one, a plurality of the cameras 150 may be provided. Furthermore, the camera 150 may perform panning, tilting, or zooming.

The action evaluation system 100 receives the image data from the camera 150, and evaluates a posture or an action of the worker P included in the received image data. The action evaluation system 100 mainly includes an image data acquisition unit 101, an extraction unit 102, an action detection unit 103, a determination unit 104, a time measurement unit 105, a notification unit 106, and a storage unit 110.

The image data acquisition unit 101 acquires image data from the communicably connected camera 150. The image data acquired by the image data acquisition unit 101 can include, for example, an image obtained by photographing a series of operations such as an operation action of the inspection process of the automobile 90 performed by the worker P. The image data acquired by the image data acquisition unit 101 can include a plurality of images captured by the camera 150 every predetermined period. The image data acquisition unit may also be referred to as a video data acquisition unit.

The extraction unit 102 extracts skeleton data from the image data. More specifically, the extraction unit 102 detects an image region (body region) of the body of the person from a frame image included in the image data, and extracts the image region as a body image (for example, cutting out). Then, the extraction unit 102 extracts skeleton data of at least a part of the body of the person based on features such as joints of the person recognized in the body image using a skeleton estimation technique using machine learning. The skeleton data is information including a “key point” that is a characteristic point such as a joint and a “bone link” indicating a link between key points. The extraction unit 102 may use, for example, a skeleton estimation technique such as OpenPose. In the present disclosure, the bone link described above may be simply referred to as a “bone”. The bone means a pseudo skeleton.

The action detection unit 103 detects a predetermined unit action associated with the posture of the worker from the extracted skeleton data of the worker. When detecting the unit action, the action detection unit 103 searches for a registration action (also referred to as an action pattern or a unit action pattern) registered in a registration action database 111. Then, when skeleton data of the worker and skeleton data related to the registration action are similar to each other, the action detection unit 103 recognizes this skeleton data as a unit action. That is, when detecting a registration action similar to the skeleton data of the worker, the action detection unit 103 recognizes an action related to the skeleton data as a unit action in association with the registration action. The action detection unit 103 can also recognize a type of unit action by detecting a start action and an end action in the unit action.

In the above-described similarity determination, the action detection unit 103 detects the unit action by calculating the similarity of the forms of the elements constituting the skeleton data. As an element of the skeleton data, a pseudo joint point or a skeleton structure for indicating a posture of the body is set. The form of the elements constituting the skeleton data can also be referred to as, for example, a relative geometric relationship of positions, distances, angles, and the like of other key points or bones when a certain key point or bone is used as a reference. Alternatively, the form of the elements constituting the skeleton data can also be, for example, one integrated form formed by a plurality of key points or bones.

The action detection unit 103 analyzes whether or not the relative forms of the elements are similar between two pieces of skeleton data to be compared. At this time, the action detection unit 103 calculates similarity between the two pieces of skeleton data. When calculating the similarity, the action detection unit 103 can calculate the similarity by, for example, a feature amount calculated from elements included in the skeleton data. Note that a calculation target of the action detection unit 103 may be, instead of the similarity, a similarity between a part of extracted skeleton data and skeleton data related to the registration action, a similarity between the extracted skeleton data and a part of the skeleton data related to the registration action, or a similarity between a part of the extracted skeleton data and a part of the skeleton data related to the registration action.

Note that the action detection unit 103 may calculate the similarity described above by directly using the skeleton data or indirectly using the skeleton data. For example, the action detection unit 103 may convert at least a part of the skeleton data into another format and calculate the similarity described above using the converted data. In this case, the similarity may be the similarity itself between pieces of the converted data, or may be a value calculated using the similarity between pieces of the converted data.

A method of conversion may be normalization of the size of the skeleton data or conversion into a feature amount using an angle (that is, a degree of bending of the joint) formed by a skeleton structure. Alternatively, the method of conversion may be a feature amount that is invariant to a three-dimensional posture direction, size, and the like converted by a trained model of machine learning trained in advance. By normalizing and comparing posture information, it is possible to compare images even when the images are not images of the same person captured at the same place and the same camera (angle of view). For example, when the similarity is determined based on skeleton data, the size of which is normalized, efficiency of videos of the worker A and the worker B having different physiques can be compared. Alternatively, for example, when similarity is determined based on the feature amount invariant to a direction converted by a machine learning model, efficiency of the worker A photographed from the front can be compared with efficiency of the worker B photographed from the back.

Note that the action detection unit 103 may detect a unit action from skeleton data extracted from one piece of image data. In addition, the action detection unit 103 may analyze an operation action of the worker in time series from skeleton data extracted from each of a plurality of pieces of image data photographed at a plurality of different times. With such a configuration, the action evaluation system 100 can flexibly analyze an action in accordance with a state of change in the unit action to be detected.

The action detection unit 103 may detect a plurality of unit actions at a plurality of different times from a series of operations performed by the worker. In this case, the determination unit 104 determines whether or not the series of operations includes a unit action similar to each of a plurality of different registration actions. With such a configuration, the action evaluation system 100 can suitably analyze an action that is allowed to randomly perform a plurality of types of motions.

The action detection unit 103 may acquire an order in which a plurality of unit actions is detected. Furthermore, in this case, the determination unit 104 determines whether or not the plurality of unit actions included in the series of operations has been detected in a predetermined order. With such a configuration, the action evaluation system 100 can suitably analyze that the action is performed according to a procedure.

In addition to the above-described functions, the action detection unit 103 may specify a person existing in a predetermined region of the image data as the worker P. In this case, the action detection unit 103 sets a predetermined region in the image data captured by the camera 150, and specifies a person existing in the set region. More specifically, for example, the action detection unit 103 sets a rectangular region (bounding box) in the acquired image, and specifies a person whose foot is included in the set rectangular region as the worker P. With such a configuration, the action evaluation system 100 can efficiently perform action analysis on an image including a person who is not an analysis target.

Furthermore, the action detection unit 103 may start analysis of a series of operations when the worker P enters the inside the predetermined region from the outside. That is, the action detection unit 103 can efficiently start analysis using entrance of the worker P into an operation region where the series of operations is performed as a trigger. Furthermore, the action detection unit 103 may end analysis of the operation action when the worker P goes out from the inside of the predetermined region. That is, the action detection unit 103 can end analysis using exit of the worker P from the operation region where the series of operations is performed as a trigger. In the above case, the action detection unit 103 may start analysis when the worker P goes out from the inside of the predetermined region, and end analysis when the worker P goes in from the outside of the predetermined region.

The action detection unit 103 may also include a position specification unit. The position specification unit specifies a position (for example, a position of a worker near an automobile or the like to be inspected at an operation site) of the worker in an operation site. For example, since an angle of view of the camera is fixed to the operation site, a correspondence relationship between a position of the work in the photographed image and a position of the worker in the operation site can be defined in advance, and the position in the image can be converted to the position in the operation site based on the definition. More specifically, in a first process, a height, an azimuth angle, and an elevation angle at which the camera that captures the image of the inside of the operation site is installed, and a focal length (hereinafter referred to as a camera parameter) of the camera are estimated from the captured image using an existing technology. These may be actually measured or a specification may be referred to. In a second process, the position where the foot of the person is located is converted from two-dimensional coordinates (hereinafter referred to as image coordinates) on the image to three-dimensional coordinates (hereinafter referred to as world coordinates) in the real world based on the camera parameters using the existing technology. The conversion from the image coordinates to the world coordinates is usually not uniquely determined, but the conversion can be uniquely performed by fixing the coordinate value in the height direction of the foot to zero, for example. In a third process, a map in the three-dimensional transportation means is prepared in advance, and the world coordinates obtained in the second process are projected onto the map, whereby the position of the worker in the operation site can be specified.

The action detection unit 103 may further include a recognition means for recognizing an object included in the image data by a known image recognition technology. The action detection unit 103 can recognize an object accompanying the worker by the recognition means, and detect a type of unit action included in a series of operations based on the recognized object (for example, a bonnet, an engine, a radiator, a tank, and the like).

The determination unit 104 determines whether or not the unit action detected by the action detection unit 103 matches a predetermined registration action included in the registration action database 111. The registration action is data (also referred to as reference action or reference data) registered in advance as a sample of action normally performed in the operation action. The registration action is indicated by the skeleton data. Data related to the registration action is included in the registration action database.

The determination unit 104 may determine whether or not the detected skeleton data of the worker related to the unit action is similar to the skeleton data as the registration action. That is, in this case, the action evaluation system 100 determines the correspondence relationship in the case of having a similarity greater than a predetermined threshold while permitting that the skeleton data of the unit action and the skeleton data of the registration action are not the same. With such a configuration, the action evaluation system 100 can suitably determine an action including an ambiguous portion.

The determination unit 104 can compare one or more unit actions included in the registration action as a sample with one or more unit actions performed by the worker, and identify a unit action that matches or does not match.

For example, in a certain registration action, one or more first and last unit actions are determined in advance, and an order of a series of operations therebetween is a unit action that can be determined at the discretion of the worker. In this case, the determination unit 104 determines whether or not the first and last unit actions in the registration action match unit actions performed by the worker. Furthermore, the determination unit 104 determines whether or not two or more unit actions between the first and last unit actions in the registration action include one or more unit actions performed by the worker regardless of the operation order. That is, the determination unit 104 can determine an extra action of the worker that is not included in the registration action or an action that is included in the registration action but is forgotten by the worker.

The time measurement unit 105 measures a total time required for the series of operations as an index of operation efficiency of the worker. Furthermore, the time measurement unit 105 can measure a time of each of one or more unit actions, and can also measure a time between the unit actions. As a result, it is possible to evaluate not only operation efficiency of the unit action but also efficiency of a time for determining an operation to be performed next by the worker between the unit actions.

The notification unit 106 reports evaluation information or an alert related to a determination result, a measurement time, and the like with regard to an operation of the worker P. For example, the notification unit 106 may include a speaker for reporting the determination result, the measurement time, and the like by voice. In this case, the notification unit 106 outputs an alert sound for alerting the worker P in accordance with signals of the determination result, the measurement time, and the like. received from the determination unit 104 and the time measurement unit 105. The notification unit 106 further includes a comparison and evaluation means for performing comparison and evaluation between the series of operations performed by the worker and a reference operation stored in advance. The comparison and evaluation means can compare a time of the series of operations performed by the worker with the reference time of the reference operation stored in advance and output (or display) a comparison result. There are also various examples of outputting an alert.

In a first example, in a case where a standard operation to be performed by the worker P is registered in the registration action, when the unit action in the series of operations performed by the worker P does not match the registration action, the notification unit 106 outputs an alert sound.

In a second example, in a case where a registration action (also referred to as an NG registration action pattern or an unnecessary action pattern) as a unit action that the worker P should not perform is registered, when a unit action in an operation action of an example performed by the worker P matches the registration action, the notification unit 106 outputs an alert sound.

In a third example, in a case where a total time required for the series of operations exceeds a threshold, the notification unit 106 outputs an alert sound.

In a fourth example, in a case where a time required for one or more unit actions exceeds a threshold, the notification unit 106 outputs an alert sound.

In a fifth example, in a case where one or more time intervals between the unit actions exceed a threshold, the notification unit 106 outputs an alert sound.

Note that these alert output conditions are merely examples, and various modified examples are conceivable. In addition, the notification unit 106 may include a lamp, a buzzer, a display, or the like instead of the speaker or in addition to the speaker.

The storage unit 110 is a storage means including a non-volatile memory and the like. The storage unit 110 stores at least the registration action database 111. The registration action database 111 includes skeleton data as a registration action. Furthermore, in a case of including a plurality of unit actions, the registration action database 111 can include data related to an operation procedure (data related to one or more unit actions that can be performed in any order). Thus, the action evaluation system 100 can evaluate a series of operations having a plurality of operation procedures.

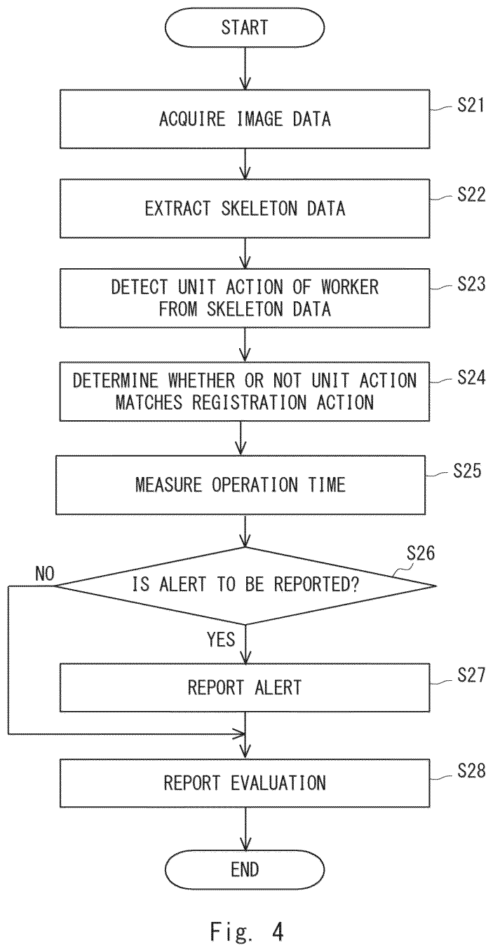

Next, processing of the action evaluation system 100 according to the present example embodiment will be described with reference to FIG. 4. FIG. 4 is a flowchart illustrating an action evaluation method according to the second example embodiment. The action evaluation system 100 according to the flowchart illustrated in FIG. 4 evaluates a series of operations having a plurality of unit actions.

First, the image data acquisition unit 101 acquires image data from the camera 150 (step S21). The image data acquisition unit 101 supplies the acquired image data to the extraction unit 102.

Next, the extraction unit 102 cuts out an image of the worker from the received image data, and extracts skeleton data from the cut out image (step S22).

The extraction unit 102 supplies the extracted skeleton data to the action detection unit 103.

Next, the action detection unit 103 detects the unit action of the worker from the received skeleton data (step S23). When detecting the unit action, the action detection unit 103 supplies the extracted unit action to the determination unit 104.

Next, the determination unit 104 compares the received unit action with the registration action database 111 stored in the storage unit 110, and determines whether or not the unit action matches the registration action (step S24). For example, in some example embodiments, when the first and last unit actions in the registration action are determined, it is determined whether or not the first and last unit actions match first and last unit actions performed by the worker. In some example embodiments, when an operation order for at least two or more unit actions between the first and last unit actions in the registration action is not determined, the determination unit 104 determines whether or not two or more unit actions between the first and last unit actions in the registration action include one or more unit actions performed by the worker regardless of the operation order. That is, the determination unit 104 can determine an extra action of the worker that is not included in the registration action or an action that is included in the registration action but is forgotten by the worker. In addition, the determination unit 104 supplies a determination result to the time measurement unit 105.

Next, the time measurement unit 105 measures a total time required for a series of operations, a time of one or more unit actions, and a time between the unit actions (step S25).

The notification unit 106 determines whether or not to report an alert from the determination result received from the determination unit 104 and the operation time received from the time measurement unit 105 (step S26). Note that a condition of reporting the alert may be, for example, one of the above-described five conditions or other conditions. When it is determined that an alert is to be reported (step S26: YES), the determination unit 104 or the time measurement unit 105 supplies a signal instructing report of an alert to the notification unit 106. In this case, the notification unit 106 notifies the worker P of a predetermined alert (step S27), and the operation proceeds to step S28. On the other hand, when it is determined that the alert is not to be reported (step S25: NO), step S27 is skipped, and the process proceeds to step S28.

The notification unit 104 of the action evaluation system 100 reports an evaluation result from the determination result received from the determination unit 104 and the operation time received from the time measurement unit 105 (step S28). An evaluation result related to operation efficiency may include a total time required for the series of operations, a time of one or more unit actions, and a time between the unit actions. For example, an evaluation result related to a determination result may indicate an extra action of the worker that is not included in the registration action or a unit action that is included in the registration action but is forgotten by the worker. Thereafter, the action evaluation system 100 ends the processing.

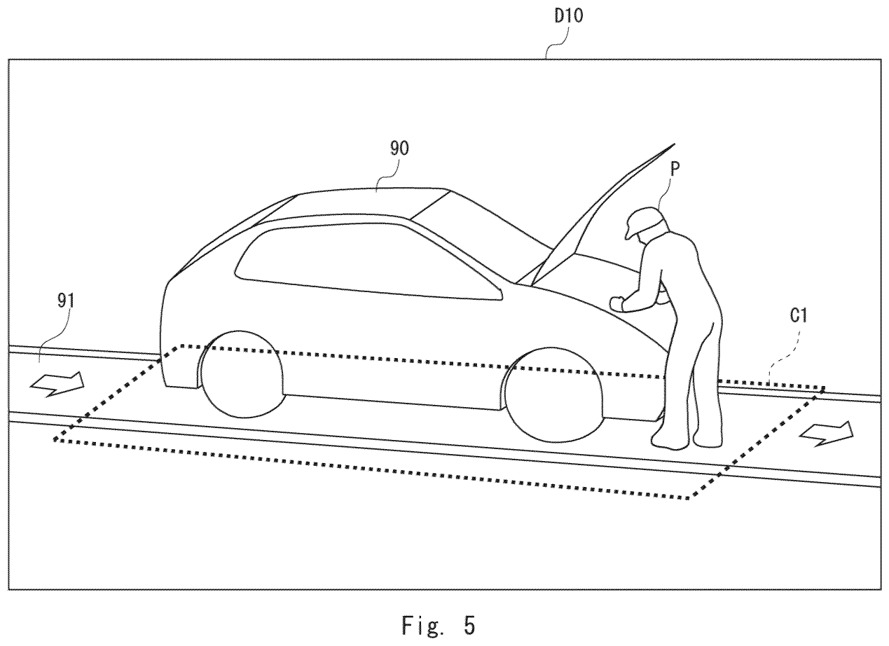

FIG. 5 is a diagram illustrating an example of image data acquired by the action evaluation system. FIG. 5 illustrates an image D10 captured by the camera 150. The image D10 includes the worker P, the automobile 90, a conveyor 91, and an operation region C1.

The worker P inspects the automobile 90 as a predetermined operation action. The automobile 90 is an object on which the worker P performs an operation. The automobile 90 is conveyed by the conveyor 91 from the left side of the image D10 and stopped inside the operation region C1. The conveyor 91 conveys the automobile 90 by moving from left to right of FIG. 5 according to a predetermined operation. The operation region C1 is a region defined by the action evaluation system 100 and is indicated by a thick dotted line in the image D10. The operation region C1 indicates a place defined as a place where the worker P inspects the automobile 90.

The worker P stands by away from the conveyor 91 before the automobile 90 is conveyed. When the automobile 90 is conveyed by the conveyor 91, the worker P enters the operation region C1 and starts a predetermined operation. The camera 150 supplies image data generated by capturing the above-described state to the action evaluation system 100. Upon receiving the image data from the camera 150, the action evaluation system 100 starts analysis of an action of the worker P using intrusion of the worker P into the operation region C1 illustrated in the image D10 as a trigger. Note that the automobile 90 may enter the operation region C1 by self-running, for example, instead of being conveyed by the conveyor 91. In this case, the worker P or another worker may drive the automobile 90 from a process before the operation region C1 and stop the automobile 90 in the operation region C1.

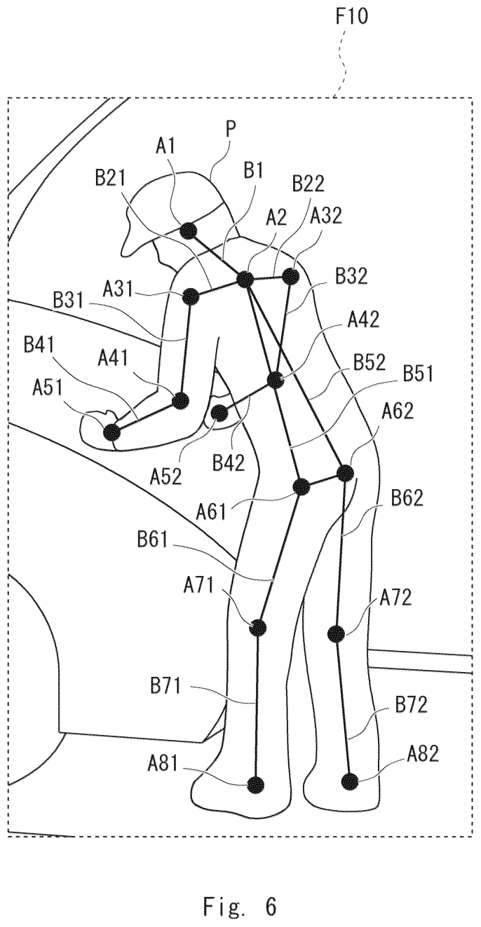

Next, an example of detecting a posture of the worker P will be described with reference to FIG. 6. FIG. 6 is a diagram illustrating skeleton data extracted from image data. The image illustrated in FIG. 6 is a body image F10 obtained by extracting the body of the worker P from the image illustrated in FIG. 5. In the action evaluation system 100, the extraction unit 102 cuts out the body image F10 from the image D10 illustrated in FIG. 5, and further sets a skeleton structure.

The extraction unit 102 extracts, for example, a feature point that can be a key point of a person from the image. Further, the extraction unit 102 detects a key point from the extracted feature point. When detecting the key point, the extraction unit 102 refers to, for example, information obtained by machine learning on an image of the key point.

In the example illustrated in FIG. 6, the extraction unit 102 detects a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82 as key points of the worker P.

Furthermore, the extraction unit 102 sets bones connecting these key points as a pseudo skeleton structure of the worker P as follows. A bone B1 connects the head A1 and the neck A2. A bone B21 connects the neck A2 and the right shoulder A31, and a bone B22 connects the neck A2 and the left shoulder A32. A bone B31 connects the right shoulder A31 and the right elbow A41, and a bone B32 connects the left shoulder A32 and the left elbow A42. A bone B41 connects the right elbow A41 and the right hand A51, and a bone B42 connects the left elbow A42 and the left hand A52. A bone B51 connects the neck A2 and the right waist A61, and a bone B52 connects the neck A2 and the left waist A62. A bone B61 connects the right waist A61 and the right knee A71, and a bone B62 connects the left waist A62 and the left knee A72. Further, a bone B71 connects the right knee A71 and the right foot A81, and a bone B72 connects the left knee A72 and the left foot A82. After generating the skeleton data with regard to the above-described skeleton structure, the extraction unit 102 supplies the generated skeleton data to the action detection unit 103.

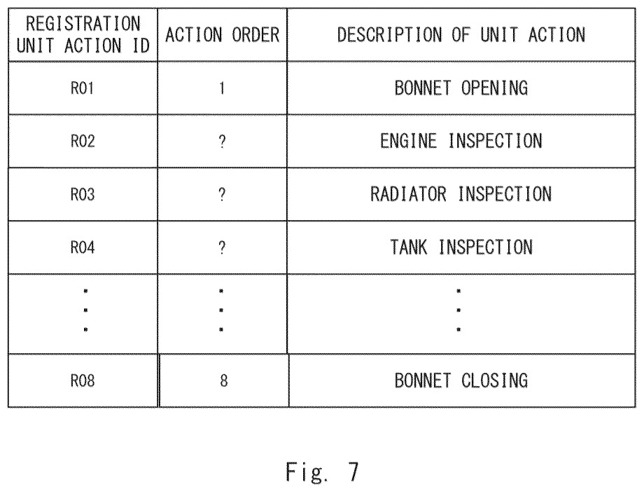

Next, an example of the registration action database 111 will be described with reference to FIG. 7. FIG. 7 is a table illustrating an example of a registration action stored in the storage unit 110 according to the second example embodiment. In the table illustrated in FIG. 7, a registration action ID (identification, identifier), an action order, and description of an action are associated with each other. An action order of a registration action ID (or action ID) “R01” is “1”, and description of an action is “bonnet opening”. An action order of a registration action ID “R02” is in any action order, and thus is indicated by “?”, and description of an action is “engine inspection”. An action order of a registration action ID “R03” is in any action order, and thus is indicated by “?”, and description of an action is “radiator inspection”. An action order of a registration action ID “R04” is in any action order, and thus is indicated by “?”, and description of an action is “tank inspection”. An action order of a registration action ID “R08” is “8”, and description of an action is “bonnet closing”. Note that the registration action of the worker performed in any order described here is an example, and various modified examples can be assumed.

In addition, the first registration action (bonnet opening having the registration action ID of R01) may be used as a trigger for starting the operation of the action detection unit 103. The last registration action (bonnet closing having the registration action ID of R08) may be used as a trigger for terminating the operation of the action detection unit 103.

In some example embodiments, the registration action in the registration action database 111 is stored in association with position information of the operation site. As described above, the action of the worker may be specified by specifying a position of the worker and comparing a registration action associated with the specified position with an action performed by the worker.

As described above, data related to the registration action included in the registration action database 111 is assigned with an action ID and an action order (any order is possible) for each action. In addition, each registration action includes skeleton data. That is, for example, the registration action having the action ID “R01” includes skeleton data indicating an action of opening the bonnet.

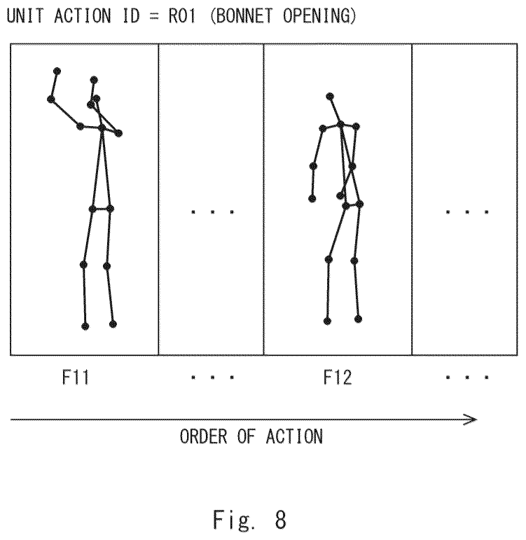

The skeleton data according to the registration unit action will be described with reference to FIG. 8. FIG. 8 is a diagram illustrating a first example of skeleton data in the registration unit action. FIG. 8 illustrates skeleton data related to an action whose unit action ID related to bonnet opening illustrated in FIG. 7 is “R01” among registration unit actions included in the registration action database 111. FIG. 8 illustrates a plurality of pieces of skeleton data including skeleton data F11 and skeleton data F12 in a state of being arranged in a left-right direction. The skeleton data F11 is located on the left side of the skeleton data F12. The skeleton data F11 is a posture in which both arms are raised while the person is standing. The skeleton data F12 is a posture in which both arms are lowered while the person is standing.

This means that the registration action having the unit action ID “R01” is that the person takes the posture of the skeleton data F12 after taking the posture corresponding to the skeleton data F11. Note that, even though two pieces of skeleton data have been described here, the registration action having the unit action ID “R01” may include skeleton data other than the above-described skeleton data.

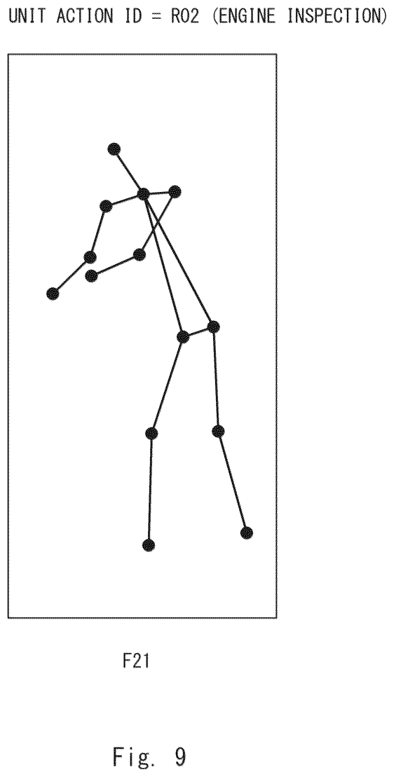

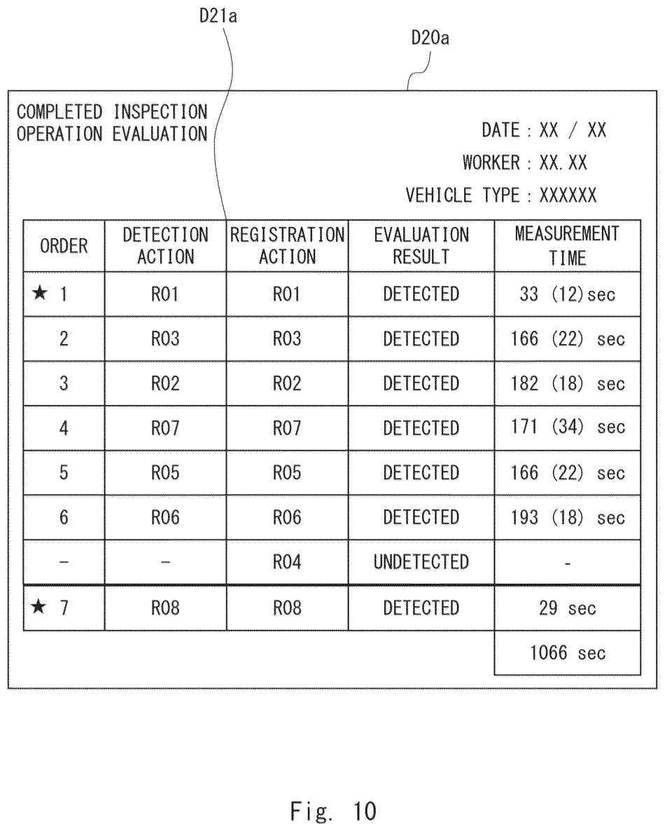

The skeleton data according to the registration action will be further described with reference to FIG. 9. FIG. 9 is a diagram illustrating a second example of skeleton data in the registration action. FIG. 9 illustrates skeleton data F21 related to the action whose unit action ID related to engine inspection illustrated in FIG. 7 is “R02”. Only the skeleton data F21 is registered in the registration action having the unit action ID “R02”.

In this way, the registration action may be only one piece of skeleton data. The action detection unit 103 of the action evaluation system 100 compares the registration action including the above-described skeleton data with the skeleton data related to the unit action received from the extraction unit 102, and determines whether or not there is a similar registration action. In another example embodiment, a plurality of pieces of skeleton data in time series may be registered.

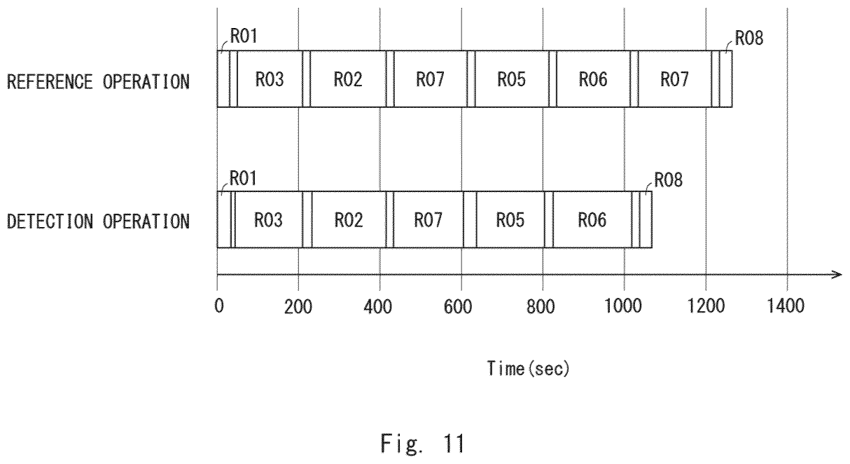

Next, an example of a determination result and a measurement result output by the action evaluation system 100 will be described with reference to FIGS. 10 to 13. FIG. 10 is a diagram illustrating an example of a determination result output by the action evaluation system according to the second example embodiment. An image D20a illustrated in FIG. 10 is obtained by displaying the determination result output by the action evaluation system 100 on a predetermined display unit (not illustrated). The image D20a indicates an evaluation status of an inspection operation of the automobile 90. This example illustrates a case where the action of the registered action “tank inspection” is not detected.

The image D20a displays information on an operation date, a worker name (attribute of the worker), and a vehicle type (attribute of the automobile 90). Further, the image D20a includes an operation evaluation display portion D21a. The operation evaluation display portion D21a displays the detected operation order, the unit action ID of the detected action of the worker, the registration action ID of the registered operation, the evaluation result, and the measurement time in association with each other. The measurement time includes a time (seconds) from start to end of the detected action of the worker and a time (seconds) until a next action is started after the action. These measurement times can represent operation efficiency of the unit action of the worker and efficiency until start of the next action.

In an order 1, a unit action ID of the detected unit action is R01. Since the detection action and the registration action match each other, the evaluation result is displayed as “detected”. This indicates that the bonnet opening action is normally performed. In addition, as the measurement time, the time (33 seconds) required for the detected action of the worker is displayed, and the time (12 seconds) until the next action is detected is displayed. As described above, the action may be a start trigger of an action detection process (indicated by a star in D21a of FIG. 10), and in some example embodiments, may not be included in an evaluation item.

In an order 2, a unit action ID of a registration action of the detected unit action is R03. Since the detection action and the registration action match each other, the evaluation result is displayed as “detected”. This indicates that the radiator inspection action has been normally performed. In addition, as the measurement time, the time (166 seconds) required for the detected action of the worker is displayed, and the time (22 seconds) until the next action is detected is displayed.

In an order 3, a unit action ID of a registration action of the detected unit action is R02. Since the detection action and the registration action match each other, the evaluation result is displayed as “detected”. This indicates that the engine inspection action has been normally performed. In addition, as the measurement time, the time (182 seconds) required for the detected action of the worker is displayed, and the time (18 seconds) until the next action is detected is displayed.

Similarly, in the orders 4 to 6, each detected action coincides with the registration action, indicating that each action has been normally performed by the worker.

On the other hand, since an action whose unit action ID of the registration action is R04 has not been detected among the registration actions, the evaluation result is displayed as “undetected”. This indicates that the tank inspection action has not been normally performed. Therefore, the measurement time is also blank.

In an order 7, a unit action ID of a registration action of the detected unit action is R08. Since the detection action and the registration action match each other, the evaluation result is displayed as “detected”. This indicates that the bonnet closing action is normally performed. Further, the measurement time indicates a time (29 seconds) required for the detected action of the worker. As described above, the action may be an end trigger of an action detection process (indicated by a star in D21a of FIG. 10), and in some example embodiments, may not be included in an evaluation item.

Further, the operation evaluation display portion D21a also displays a total time (1066 seconds) required for all inspections of the worker.

In this manner, the action evaluation system 100 can analyze and evaluate a series of actions of the worker P and measure each action. When the registration action and the detection action do not match (for example, when there is an undetected action), the action evaluation system 100 may display notification of an alert on the image D20. Note that, in another example embodiment, as illustrated in FIG. 11, the operation evaluation display portion may arrange and indicate the measurement time and the total time of each unit action required for the inspection, and a reference time and a reference total time of the registration action as a sample. Further, a measurement time between the unit actions is also displayed. In addition, when the measurement time and the total time exceed a threshold time, notification of an alert may be displayed on the image D20.

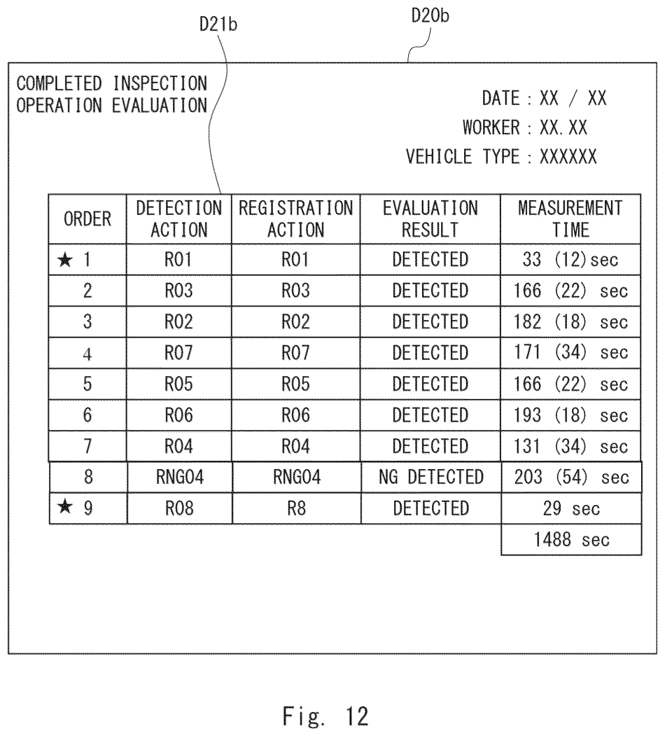

FIG. 12 is a diagram illustrating another example of another determination result and measurement result output by the action evaluation system according to the second example embodiment. This example illustrates a case where all the registered actions are detected and an NG registration action is also detected.

In FIG. 12, the orders 1 to 6 are the same as the example illustrated in FIG. 10, and thus the description thereof is omitted.

In an order 7, a unit action ID of a registration action of the detected unit action is R04. Since the detection action and the registration action match each other, the evaluation result is displayed as “detected”. This indicates that the tank inspection action has been normally performed. In addition, as the measurement time, the time (131 seconds) required for the detected action of the worker is displayed, and the time (34 seconds) until the next action is detected is displayed.

In an order 8, in the detection unit action, a unit action ID of an NG registration action that should not be performed by the worker is RNG04. Since the detection action and the NG registration action match each other, the evaluation result is displayed as “NG detected”. In addition, as the measurement time, the time (203 seconds) required for the detected action of the worker is displayed, and the time (54 seconds) until the next action is detected is displayed.

In an order 9, a unit action ID of a registration action of the detected unit action is R08. Since the detection action and the registration action match each other, the evaluation result is displayed as “detected”. This indicates that the bonnet closing action is normally performed. Further, the measurement time indicates a time (29 seconds) required for the detected action of the worker. As described above, the action is an end trigger of an action detection process, and in some example embodiments, may not be included in an evaluation item.

In this manner, the action evaluation system 100 can analyze and evaluate a series of actions of the worker P and measure each action. When the registration action and the detection action do not match (for example, when there is detection of an NG action), the action evaluation system 100 may display notification of an alert on the image D20.

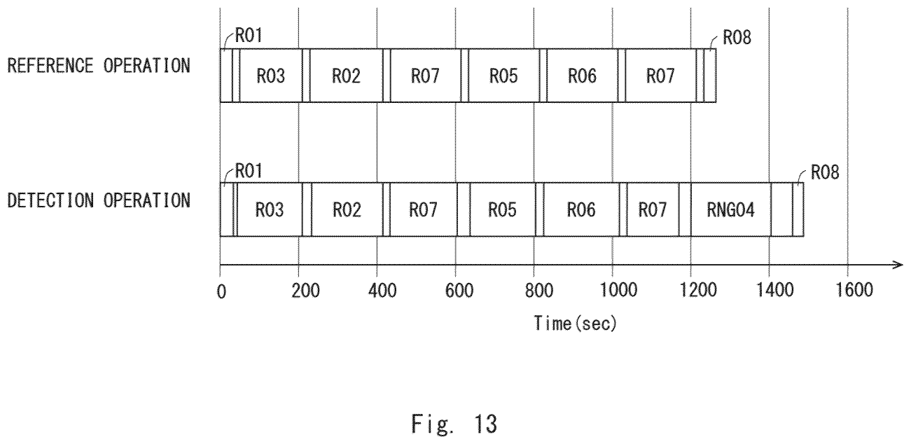

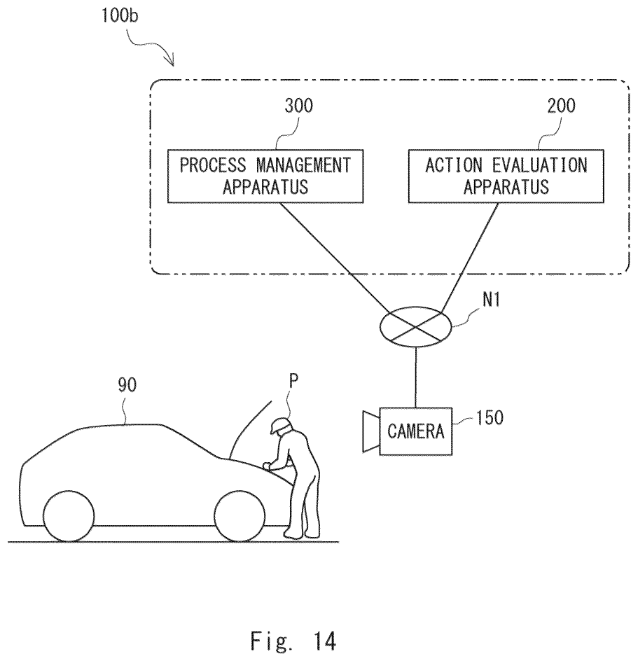

FIG. 13 is a diagram for comparing a detected operation time with a reference operation time in this example. In this example, since RNG04 has been detected in the detection operation, it can be seen that it takes more time when compared to the reference operation.

Even though the second example embodiment has been described above, the action evaluation system 100 according to the second example embodiment is not limited to the above-described configuration. For example, a part of or the entire extraction unit 102 included in the action evaluation system 100 may be included in the camera 150. In this case, for example, the camera 150 may extract a body image related to the person by processing a captured image. Alternatively, the camera 150 may further extract skeleton data of at least a part of the body of the person from the body image based on features such as joints of the person recognized in the body image. When the camera 150 is responsible for such a function, the camera 150 at least provides the skeleton data to the action evaluation system 100. In addition to the skeleton data, the camera 150 may provide image data to the action evaluation system 100. In addition to the above-described configuration example, the action evaluation system 100 may include the camera 150. Alternatively, a part of or the entire element included in the action evaluation system 100 may be included in the camera 150. According to the present example embodiment, it is possible to provide an action evaluation system, an action evaluation method, and the like for appropriately evaluating efficiency of an operation performed by the worker.

### Third Example Embodiment

FIG. 14 is a diagram illustrating an overall configuration of an action evaluation system according to a third example embodiment. FIG. 14 illustrates an automobile 90, a worker P, a camera 150, and an action evaluation system 100b. The action evaluation system 100b includes an action evaluation apparatus 200 and a process management apparatus 300. The action evaluation apparatus 200 and the process management apparatus 300 are communicably connected to each other via a network N1.

### (Action Evaluation Apparatus)

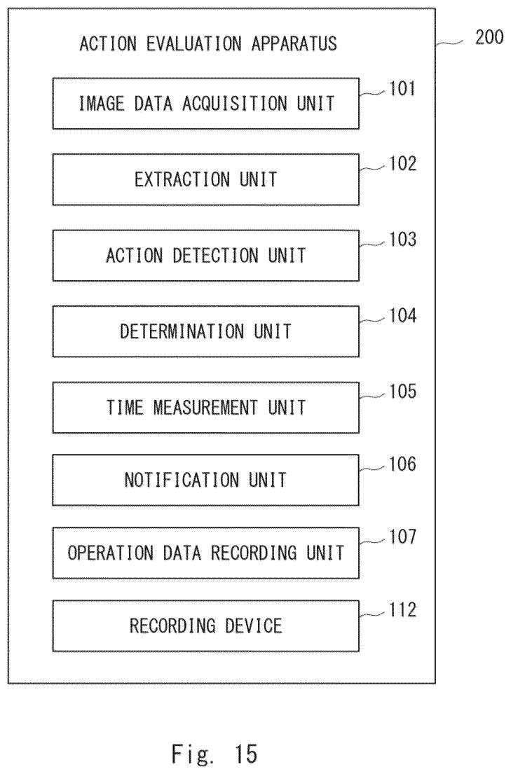

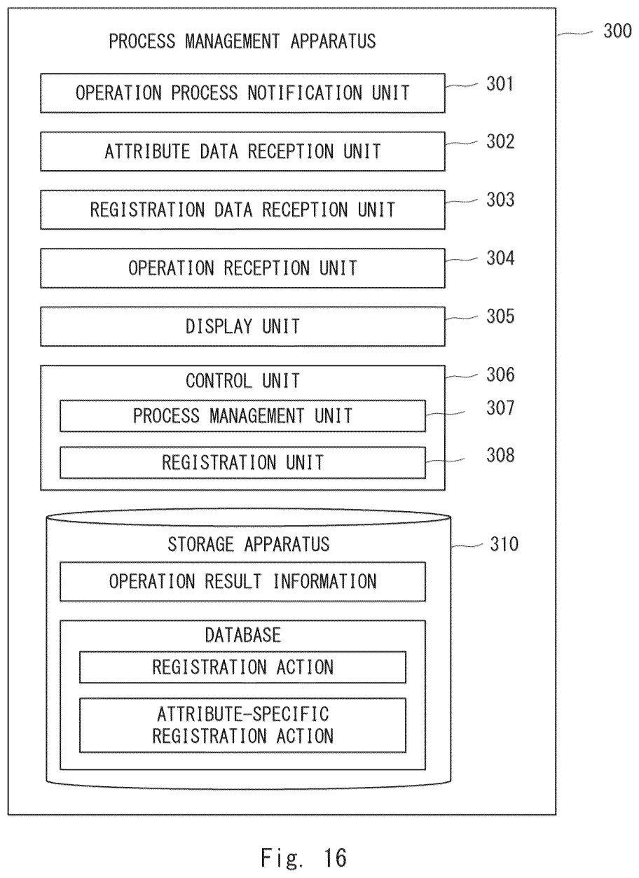

FIG. 15 is a block diagram illustrating a configuration of an action evaluation apparatus according to the third example embodiment. The action evaluation apparatus 200 includes an image data acquisition unit 101, an extraction unit 102, an action detection unit 103, a determination unit 104, a time measurement unit 105, a notification unit 106, an operation data recording unit 107, and a recording device 112. The action evaluation apparatus 200 is different from the action evaluation system 100 according to the second example embodiment in including the operation data recording unit 107 and the recording device 112.

The operation data recording unit 107 causes the recording device 112 to record at least a part of image data acquired by the image data acquisition unit 101. More specifically, for example, the operation data recording unit 107 receives the determination result and the measurement result from the determination unit 104 and the time measurement unit 105, and causes the recording device 112 to record the image data according to a predetermined condition according to the determination result and the measurement result. The predetermined condition set here may be, for example, similar to the condition for reporting an alert in the second example embodiment. Alternatively, the predetermined condition may be another condition.

The recording device 112 is a non-volatile recording device such as a solid state drive (SSD), a hard disk drive (HDD), or a flash memory. The recording device 112 records an operation action image including at least a unit action for which determination as to whether or not the unit action is similar to the registration action has been made so that the operation action image can be reproduced. The operation action image recorded by the recording device 112 may be an object including an image captured by the camera 150 or may include skeleton data extracted from image data. The recording device 112 may be configured integrally with the action evaluation apparatus 200, or may be physically detachable from the action evaluation apparatus 200.

Note that the action evaluation apparatus 200 according to the present example embodiment does not include the registration action database 111. However, the action evaluation apparatus 200 acquires data corresponding to the registration action database 111 from the process management apparatus 300 communicably connected. In addition, when content of the operation performed by the worker P is changed, the action evaluation apparatus 200 can receive data corresponding to the registration action database 111 from the process management apparatus 300 in a timely manner.

### (Process Management Apparatus)

FIG. 16 is a block diagram illustrating a configuration of the process management apparatus 300 according to the third example embodiment. The process management apparatus 300 mainly includes an operation process notification unit 301, an attribute data reception unit 302, a registration data reception unit 303, an operation reception unit 304, a display unit 305, a control unit 306, and a storage apparatus 310. The process management apparatus 300 may be a dedicated apparatus having the above-described configuration, or may be, for example, a server, a personal computer, a tablet PC, a smartphone, or the like.

The operation process notification unit 301 notifies the action evaluation apparatus 200 of operation process data. The operation process is data including a plurality of registration actions included in a series of operations performed on the automobile 90 as an operation object. For example, when an attribute of the automobile 90, which is an operation object of an operation performed by the worker P, is changed, the operation process notification unit 301 reports operation process data.

The attribute data reception unit 302 is also referred to as an attribute data reception means, and receives attribute data of the operation object. The attribute data reception unit 302 in the present example embodiment receives, for example, data indicating a type of the automobile 90, a name of the automobile 90, a serial number or a lot number of the automobile 90, and the like as attribute data of the automobile 90 which is an operation object. The attribute data reception unit 302 may receive attribute data from another apparatus that manages a manufacturing process of the automobile 90, for example. Alternatively, the attribute data reception unit 302 may receive the attribute data by reading data input by a user who uses the action evaluation apparatus 200. The attribute data reception unit 302 may have a function of recognizing an attribute of the automobile 90 from image data by further having a recognition function including functions of object recognition and character reading.

In the above-described case, the operation process notification unit 301 supplies an operation process corresponding to the attribute data received by the attribute data reception unit 302 to the action evaluation apparatus 200. In addition, the action detection unit 103 and the determination unit 104 of the action evaluation apparatus 200 determine whether or not a unit action is similar to a registration action corresponding to the attribute data described above.

With such a configuration, for example, when manufacturing a plurality of different types of operation objects in the same manufacturing line, the action evaluation system 100b can easily address action evaluation according to the operation objects. That is, the action evaluation system 100b can efficiently evaluate an operation performed by the worker.

For the purpose of registering the registration action, the registration data reception unit 303 receives image data for generating the registration action and data accompanying the image data. The data accompanying the image data is, for example, the type or name of the automobile 90 corresponding to the registration action, data related to the order of the registration action, and the like.

The operation reception unit 304 includes an input means such as a keyboard or a touch panel, for example, and receives an operation from a user who operates the process management apparatus 300. The display unit 305 is a display including a liquid crystal panel or organic electroluminescence.

The control unit 306 includes an arithmetic apparatus such as a central processing unit (CPU) or a micro controller unit (MCU), and controls each configuration of the process management apparatus 300. The control unit 306 includes a process management unit 307 and a registration unit 308.

The process management unit 307 manages an operation process performed by the worker P. More specifically, the process management unit 307 recognizes a status of an operation process performed by the worker P using, for example, various data stored in the storage apparatus 310 and data appropriately acquired from another device related to a manufacturing process of the automobile 90. In addition, the process management unit 307 controls data exchange between the process management apparatus 300 and the action evaluation apparatus 200 according to the recognized operation process. The registration unit 308 processes the data received by the registration data reception unit 303 and stores the registration action in the storage apparatus 310 as appropriate.

The storage apparatus 310 includes at least a non-volatile memory, and store operation result information, a measurement result, and a database. The operation result information includes information including a progress status of the operation process and information related to a result of determination performed by the action evaluation apparatus 200. The database includes a registration action corresponding to the registration action database 111. In addition, the database includes an attribute-specific registration action that is a registration action associated with an attribute of the operation object.

Even though the process management apparatus 300 has been described above, the process management apparatus 300 may further include a specification means for specifying the worker as an individual in addition to the above-described configuration. In this case, for example, the action evaluation system 100b recognizes that the worker P is a registered specific person, and performs processing using a registration action of the specific person. The determination unit 104 of the action evaluation apparatus 200 determines whether or not the unit action related to the specified individual is similar to a predetermined registration action related to the individual. As a result, the action evaluation system 100b can evaluate the operation action in association with the individual.

The specification means of the worker can also specify a position of the worker. A position specification means specifies a position (for example, a position of a worker near an automobile or the like to be inspected at an operation site) of the worker in an operation site. For example, since an angle of view of the camera is fixed to the operation site, a correspondence relationship between a position of the work in the photographed image and a position of the worker in the operation site can be defined in advance, and the position in the image can be converted to the position in the operation site based on the definition. More specifically, in a first process, a height, an azimuth angle, and an elevation angle at which the camera that captures the image of the inside of the operation site is installed, and a focal length (hereinafter referred to as a camera parameter) of the camera are estimated from the captured image using an existing technology. These may be actually measured or a specification may be referred to. In a second process, the position where the foot of the person is located is converted from two-dimensional coordinates (hereinafter referred to as image coordinates) on the image to three-dimensional coordinates (hereinafter referred to as world coordinates) in the real world based on the camera parameters using the existing technology. The conversion from the image coordinates to the world coordinates is usually not uniquely determined, but the conversion can be uniquely performed by fixing the coordinate value in the height direction of the foot to zero, for example. In a third process, a map in the three-dimensional transportation means is prepared in advance, and the world coordinates obtained in the second process are projected onto the map, whereby the position of the worker in the operation site can be specified.

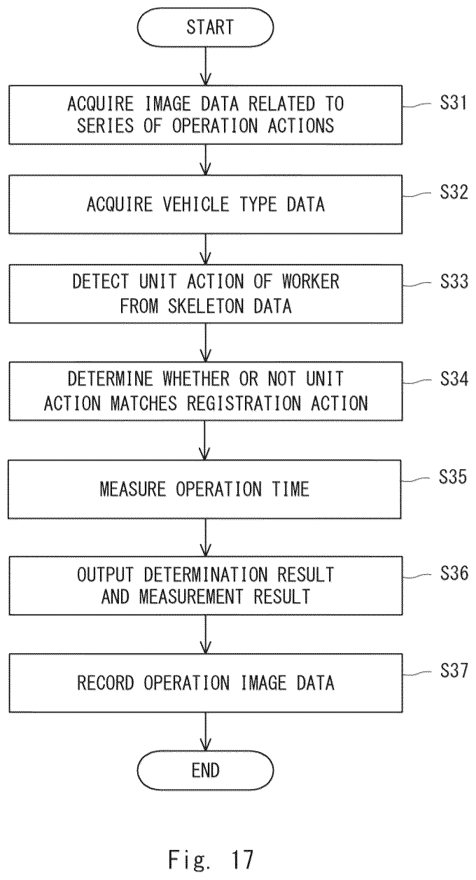

Next, processing executed by the action evaluation system 100b will be described. FIG. 17 is a flowchart illustrating an action evaluation method according to the third example embodiment.

First, the image data acquisition unit 101 of the action evaluation apparatus 200 acquires image data related to a series of operations (step S31). Here, the image data acquisition unit 101 can collectively acquire images of a plurality of frames.

Next, the process management apparatus 300 acquires vehicle type data (step S32). The process management apparatus 300 supplies the received vehicle type data to the action evaluation apparatus 200.

Next, the action evaluation apparatus 200 extracts skeleton data from the acquired image data, and detects the unit action of the worker from the extracted skeleton data (step S33). Note that, when the action evaluation apparatus 200 detects the unit action, a registration action corresponding to the vehicle type data acquired by the process management apparatus 300 is used. Next, the determination unit 104 of the action evaluation apparatus 200 determines whether or not the unit action matches the registration action (step S34).

Next, the time measurement unit 105 measures the detected time of each unit action and a series of operation times (step S35). The notification unit 106 outputs the determination result and the measurement result to the operation data recording unit 107 (step S36).

Next, the operation data recording unit 107 records the operation image data (step S37), and ends the processing. Note that the action evaluation apparatus 200 appropriately supplies the stored operation image data to the process management apparatus 300 in response to a request from the process management apparatus 300.

The processing executed by the action evaluation system 100b has been described above. By executing the above-described processing, the action evaluation system 100b can cause the user to recognize the operation performed by the worker P in a state where the operation can be analyzed after the operation. The user can objectively analyze the operation of the worker P using the recorded operation image data. Therefore, the user can grasp a proficiency level and efficiency of the operation of the worker P, and determine whether or not to provide operation instruction to the worker P. Alternatively, the user can use operation image data recorded as data for objectively evaluating work performed by the worker P.

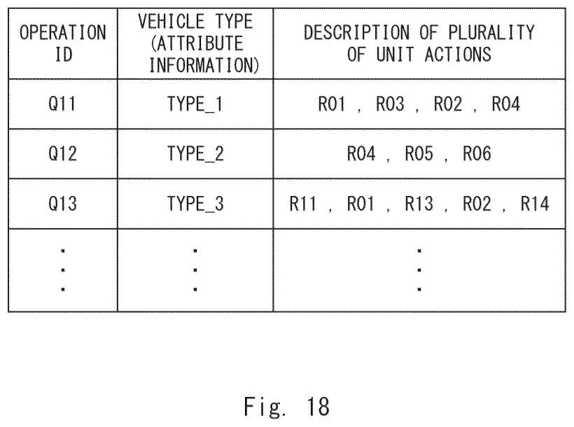

Next, an example of an operation evaluated by the action evaluation system 100b will be described with reference to FIG. 18. FIG. 18 is a table illustrating an example of an operation stored in the action evaluation system according to the third example embodiment. The table of FIG. 18 illustrates an operation ID, data related to a vehicle type as attribute information of the automobile 90, and descriptions of a plurality of unit actions.

For example, a vehicle type of an operation action having an operation ID “Q11” corresponds to TYPE_1. Further, it is indicated that descriptions of a plurality of unit actions having the operation ID “Q11” includes R01, R03, R02, and R04 using a unit action ID of the registration action separately stored in the action evaluation system 100b. Similarly, it is indicated that a vehicle type of an operation having an operation ID “Q12” corresponds to TYPE_2, and descriptions of a plurality of unit actions includes R04, R05, and R06. It is indicated that a vehicle type of an operation having an operation ID “Q13” corresponds to TYPE_3, and descriptions of a plurality of unit actions includes R11, R01, R13, R02, and R14.

As described above, the action evaluation system 100b stores operation content for each vehicle type by associating data related to a vehicle type which is attribute data of the automobile 90 which is the operation object with a registration action which is a series of operations performed on each automobile 90. Using this table, the action evaluation system 100b can suitably evaluate an operation even when products of different product types are manufactured on the same manufacturing line.

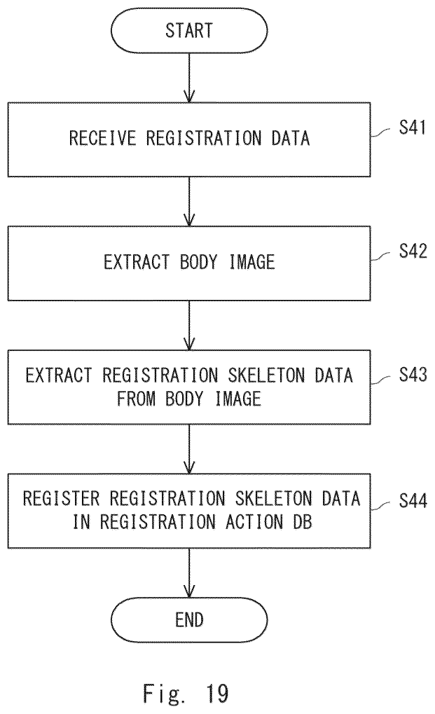

Next, an example of registering a registration action will be described with reference to FIG. 19. FIG. 19 is a flowchart illustrating processing of registering a registration action according to the third example embodiment. The flowchart illustrated in FIG. 19 starts, for example, when the registration unit 308 instructs each component to register a registration action.

First, the image data acquisition unit 101 of the action evaluation apparatus 200 receives registration image data from the camera 150 (step S41). Note that the action evaluation system 100b may acquire image data from a registration camera (not illustrated).

Next, the extraction unit 102 extracts a body image from image data related to registration data (step S42), and further extracts registration skeleton data from the body image (step S43). The extraction unit 102 supplies the extracted skeleton data to the registration data reception unit 303 of the process management apparatus 300.

Next, the process management unit 307 registers the registration data received by the registration data reception unit 303 in the registration database (step S44), and ends a series of processes.

The third example embodiment has been described above. According to the present example embodiment, it is possible to provide an action evaluation system and the like for appropriately evaluating efficiency of an operation performed by the worker.

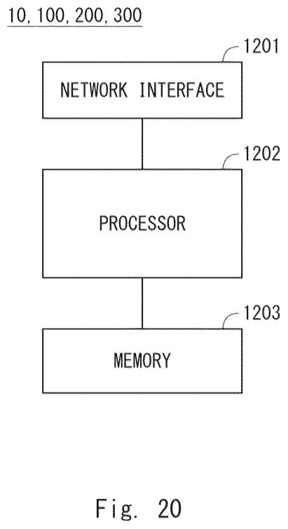

FIG. 20 is a block diagram illustrating a hardware configuration of the action evaluation system.

FIG. 20 is a block diagram illustrating a hardware configuration example of the action evaluation systems 10 and 100 (hereinafter, referred to as the action evaluation system 100 or the like). Referring to FIG. 19, the action evaluation system 100 or the like includes a network interface 1201, a processor 1202, and a memory 1203. The network interface 1201 is used to communicate with other network node apparatuses that configure the communications system. The network interface 1201 may be used to perform wireless communication. For example, the network interface 1201 may be used to perform wireless LAN communication defined in IEEE 802.11 series or mobile communication defined in 3rd Generation Partnership Project (3GPP). Alternatively, the network interface 1201 may include, for example, a network interface card (NIC) in conformity with IEEE 802.3 series.

The processor 1202 performs processing of the action evaluation system 100 and the like described using the flowchart or sequence in the above-described example embodiments by reading and executing software (a computer program) from the memory 1203. The processor 1202 may be, for example, a microprocessor, a micro processing unit (MPU), or a central processing unit (CPU). The processor 1202 may include a plurality of processors.

The memory 1203 is configured in a combination of a volatile memory and a nonvolatile memory. The memory 1203 may include a storage disposed away from the processor 1202. In this case, the processor 1202 may access the memory 1203 through an I/O interface (not illustrated).

In the example of FIG. 20, the memory 1203 is used to store a software module group. The processor 1202 can perform processing of the action evaluation system 100 or the like described in the above-described example embodiment by reading and executing these software module groups from the memory 1203.

As described with reference to the flowchart, each of the processors included in the action evaluation system 100 or the like executes one or a plurality of programs including a command group causing a computer to perform the algorithm described with reference to the drawings.

Note that, in the above-described example embodiment, the configuration of the hardware has been described, but the present disclosure is not limited thereto. The present disclosure can also be implemented by causing a processor to execute a computer program.

In the above-described example, the program includes a group of instructions (or software code) for causing a computer to perform one or more functions described in the example embodiments when being read by the computer. The program may be stored in a non-transitory computer-readable medium or a tangible storage medium. By way of example, and not limitation, computer-readable media or tangible storage media include random-access memory (RAM), read-only memory (ROM), flash memory, solid-state drive (SSD) or other memory technology, CD-ROM, digital versatile disc (DVD), Blu-ray® disc or other optical disk storage, magnetic cassettes, magnetic tape, magnetic disk storage, or other magnetic storage devices. The program may be transmitted on a transitory computer-readable medium or a communication medium. As an example and not by way of limitation, the transitory computer-readable medium or the communication medium includes electrical, optical, acoustic, or other forms of propagated signals.

Some or all of the above-described example embodiments can be described as in the following Supplementary Notes, but are not limited to the following Supplementary Notes.

### Supplementary Note 1

An action evaluation system including:
an action detection means for detecting a plurality of unit actions included in a series of operations performed by a worker from image data, according to a stored unit action pattern; and
a time measurement means for measuring a time taken for the series of operations.

### Supplementary Note 2

The action evaluation system according to Supplementary Note 1, wherein the time measurement means measures a time of each unit action included in the series of operations and a time between the unit actions.

### Supplementary Note 3

The action evaluation system according to Supplementary Note 1 or 2, wherein the action detection means sets a feature point and a pseudo skeleton of a body of a person based on the image data and detects a plurality of unit actions included in the series of operations from the image data, according to a stored unit action pattern.

### Supplementary Note 4

The action evaluation system according to any one of Supplementary

Notes 1 to 3, wherein the action detection means recognizes an action of a body of a person in time series based on the image data in a plurality of consecutive frames.

### Supplementary Note 5

The action evaluation system according to any one of Supplementary Notes 1 to 4, further including a storage means for storing the unit action pattern in a plurality of consecutive frames.

### Supplementary Note 6

The action evaluation system according to any one of Supplementary Notes 1 to 5, wherein the action detection means specifies a position of the worker from the image data, and detects a plurality of unit actions included in a series of operations performed by the worker, according to a unit action pattern associated with the specified position.

### Supplementary Note 7

The action evaluation system according to any one of Supplementary Notes 1 to 6, wherein the action detection means detects a start action and an end action of a unit action to recognize a type of the unit action.

### Supplementary Note 8

The action evaluation system according to any one of Supplementary Notes 1 to 7, wherein the action detection means detects an unnecessary action pattern included in the series of operations according to a stored unnecessary action pattern not included in the series of operations.

### Supplementary Note 9

The action evaluation system according to any one of Supplementary Notes 1 to 8, further including a recognition means for recognizing an object included in the image data,
wherein the action detection means detects a unit action included in a series of operations performed by the worker based on an object accompanying the worker.

### Supplementary Note 10

The action evaluation system according to any one of Supplementary Notes 1 to 9, further including a comparison and evaluation means for performing comparison and evaluation between a time of the series of operations performed by the worker and a time of a reference operation stored in advance.

### Supplementary Note 11

The action evaluation system according to any one of Supplementary Notes 1 to 10, wherein
the series of operations includes a plurality of unit actions performed by the worker on an operation object,
the action evaluation system further includes an attribute data reception means for receiving attribute data related to an attribute of the operation object, and
the action detection means determines whether or not a unit action is similar to a stored action pattern corresponding to the attribute, and detects the unit action.

### Supplementary Note 12

The action evaluation system according to any one of Supplementary Notes 1 to 11, wherein the series of operations includes a plurality of unit actions performed by the worker on an operation object, and the plurality of unit actions is performed in any order.

### Supplementary Note 13

An action evaluation method including:
detecting a plurality of unit actions included in a series of operations performed by a worker from image data, according to a stored unit action pattern; and
measuring a time taken for the series of operations.

### Supplementary Note 14

A non-transitory computer-readable medium storing a program for causing a computer to execute:
detecting a plurality of unit actions included in a series of operations performed by a worker from image data, according to a stored unit action pattern; and
measuring a time taken for the series of operations.

### REFERENCE SIGNS LIST

10 ACTION EVALUATION SYSTEM
11 ACTION DETECTION UNIT
12 TIME MEASUREMENT UNIT
90 AUTOMOBILE
91 CONVEYOR
100 ACTION EVALUATION SYSTEM
101 IMAGE DATA ACQUISITION UNIT
102 EXTRACTION UNIT
103 ACTION DETECTION UNIT
104 DETERMINATION UNIT
105 TIME MEASUREMENT UNIT
106 NOTIFICATION UNIT
107 OPERATION DATA RECORDING UNIT
110 STORAGE UNIT
111 REGISTRATION ACTION DATABASE
112 RECORDING DEVICE
150 CAMERA
200 ACTION EVALUATION APPARATUS
300 PROCESS MANAGEMENT APPARATUS
301 OPERATION PROCESS NOTIFICATION UNIT
302 ATTRIBUTE DATA RECEPTION UNIT
303 REGISTRATION DATA RECEPTION UNIT
304 OPERATION RECEPTION UNIT
305 DISPLAY UNIT
306 CONTROL UNIT
307 PROCESS MANAGEMENT UNIT
308 REGISTRATION UNIT
310 STORAGE APPARATUS
N1 NETWORK

What is claimed is:

1. An action evaluation system comprising:
at least one memory storing instructions, and at least one processor configured to execute the instructions to;
detect a plurality of unit actions included in a series of operations performed by a worker from image data, according to a stored unit action pattern; and
measure a time taken for the series of operations.

2. The action evaluation system according to claim 1, wherein the at least one processor is configured to execute the instructions to measure a time of each unit action included in the series of operations and a time between the unit actions.

3. The action evaluation system according to claim 1, wherein the at least one processor is configured to execute the instructions to set a feature point and a pseudo skeleton of a body of a person based on the image data and detects a plurality of unit actions included in the series of operations from the image data, according to a stored unit action pattern.

4. The action evaluation system according to claim 1, wherein the at least one processor is configured to execute the instructions to recognize an action of a body of a person in time series based on the image data in a plurality of consecutive frames.

5. The action evaluation system according to claim 1, wherein the at least one processor is further configured to execute the instructions to store the unit action pattern in a plurality of consecutive frames.

6. The action evaluation system according to claim 1, wherein the at least one processor is configured to execute the instructions to specify a position of the worker from the image data; and detect a plurality of unit actions included in a series of operations performed by the worker, according to a unit action pattern associated with the specified position.

7. The action evaluation system according to claim 1, wherein the at least one processor is configured to execute the instructions to detect a start action and an end action of a unit action to recognize a type of the unit action.

8. The action evaluation system according to claim 1, wherein the at least one processor is configured to execute the instructions to detect an unnecessary action pattern included in the series of operations according to a stored unnecessary action pattern not included in the series of operations.

9. The action evaluation system according to claim 1, wherein at least one processor is configured to execute the instructions to recognize an object included in the image data; and
wherein the action detection means detects detect a unit action included in a series of operations performed by the worker based on an object accompanying the worker.

10. The action evaluation system according to claim 1, wherein at least one processor is configured to execute the instructions to further perform comparison and evaluation between a time of the series of operations performed by the worker and a time of a reference operation stored in advance.

11. The action evaluation system according to claim 1, wherein
the series of operations includes a plurality of unit actions performed by the worker on an operation object,
the at least one processor is configured to execute the instructions to receive attribute data related to an attribute of the operation object;
determine whether or not a unit action is similar to a stored action pattern corresponding to the attribute; and detect the unit action.

12. The action evaluation system according to claim 1, wherein the series of operations includes a plurality of unit actions performed by the worker on an operation object, and the plurality of unit actions is performed in any order.

13. An action evaluation method comprising:
detecting a plurality of unit actions included in a series of operations performed by a worker from image data, according to a stored unit action pattern; and
measuring a time taken for the series of operations.

14. A non-transitory computer-readable medium storing a program for causing a computer to execute:
detecting a plurality of unit actions included in a series of operations performed by a worker from image data, according to a stored unit action pattern; and
measuring a time taken for the series of operations.
